(19) United States
(12) Patent Application Publication
(10) Pub. No.: US 2008/0310857 A1
(43) Pub. Date: Dec. 18, 2008

(54) OPTICAL SPACE TRANSMISSION METHOD AND OPTICAL SPACE TRANSMISSION APPARATUS

(76) Inventor: Masaru FUSE, Osaka (JP)

Correspondence Address: WENDEROTH, LIND & PONACK L.L.P., 2033 K. STREET, NW, SUITE 800, WASHINGTON, DC, 20006, US

(21) Appl. No.: 12/137,985

(22) Filed: Jun. 12, 2008

(30) Foreign Application Priority Data
Jun. 13, 2007 (JP) 2007-156358

(51) Int. Cl. H04B 10/00

(52) U.S. Cl. 398/154

(57) ABSTRACT

An optical identification signal generation section electrical-to-optical-converts and emits identification information. A modulation section modulates information data in a predetermined modulation type determined from the identification information. An optical data signal generation section electrical-to-optical-converts and emits the modulated information data. A two-dimensional optical-to-electrical conversion section receives the optical identification signal and acquires screen information including an image of the optical identification signal. An information reading section reads predetermined pixel information from the screen information and reproduces the identification information. An optical-to-electrical conversion section optical-to-electrical-converts the optical data signal. A demodulation section demodulates the information data in the predetermined demodulation type determined from the identification information, and reproduces the information data. A screen display section displays and updates the screen information, and displays the content of the information data in a predetermined manner from the identification information.

### BACKGROUND OF THE INVENTION

1. Field of the Invention

The present invention relates to, in a wireless communication method for emitting an optical wave as an information transmission medium into free space, an optical space transmission method for transmitting/receiving information data while acquiring image information and an optical space transmission apparatus.

2. Description of the Background Art

FIG. 14 is a block diagram showing a structure of a conventional optical space transmission apparatus. Referring to FIG. 14, the conventional optical space transmission apparatus includes a first modulation section 1311, a second modulation section 1312, a first electrical-to-optical conversion section 1331, a second electrical-to-optical conversion section 1332, a two-dimensional optical-to-electrical conversion section 134, a two-dimensional storage section 136, a coordinate specification section 137, an information reading section 138, a demodulation section 139, and a screen display section 140. A first optical transmitter 1301 includes the first modulation section 1311 and the first electrical-to-optical conversion section 1331. A second optical transmitter 1302 includes the second modulation section 1312 and the second electrical-to-optical conversion section 1332. Further, an optical receiver 1303 includes the two-dimensional optical-to-electrical conversion section 134, the two-dimensional storage section 136, the coordinate specification section 137, the information reading section 138, the demodulation section 139, and the screen display section 140.

With reference to FIG. 14, the operation of the conventional optical space transmission apparatus having the above-described structure will be described. The first modulation section 1311 receives first information data, converts the first information data into a first modulated signal in a predetermined modulation type, and outputs the first modulated signal. The first electrical-to-optical conversion section 1331 converts the first modulated signal into an optical-intensity-modulated signal (or an optical-amplitude-modulated signal) and emits the optical-modulated signal into free space. Similarly, the second modulation section 1312 receives second information data, converts the second information data into a second modulated signal in a predetermined modulation type, and outputs the second modulated signal. The second electrical-to-optical conversion section 1332 converts the second modulated signal into an optical-intensity-modulated signal (or an optical-amplitude-modulated signal) and emits the optical-modulated signal into free space. The two-dimensional optical-to-electrical conversion section 134 may be, for example, an image sensor, such as a CCD and a CMOS device, in which a plurality of light-receiving elements are integrated. The two-dimensional optical-to-electrical conversion section 134 acquires two-dimensional image information (hereinafter referred to as “screen information”) regarding the space in which the first electrical-to-optical conversion section 1331 and the second electrical-to-optical conversion section 1332 (or the first optical transmitter 1301 and the second optical transmitter 1302) are positioned, converts the screen information into an electrical signal, and outputs the electrical signal.

The two-dimensional storage section 136 stores thereinto (or updates) and retain pixel information included in the screen information outputted from the two-dimensional optical-to-electrical conversion section 134, in association with coordinate information (an address) representing a position on the screen information. With respect to the screen information retained in the two-dimensional storage section 136, the coordinate specification section 137 outputs the coordinate information (A, B) corresponding to the images of the first electrical-to-optical conversion section 1331 and (or) the second electrical-to-optical conversion section 1332 (or the images of the optical-modulated signals). With respect to the screen information retained in the two-dimensional storage section 136, the information reading section 138, at predetermined time intervals, reads and outputs the pixel information corresponding to the coordinate information outputted from the coordinate specification section 137. For example, FIG. 15 shows the case where: (a) the pixel information specified by the coordinates A is read at times: t1, t2, t3, t4 . . . ; (b) the change over time of the amount of light of the coordinates A is recognized; and (c) the pixel information is outputted as a pulse signal represented by “High”/“Low”.

The demodulation section 139 receives the pixel information outputted at the predetermined time intervals from the information reading section 138, demodulates the pixel information in a demodulation type corresponding to the modulation type, and reproduces the first information data and (or) the second information data. Note that the first modulation section 1311, the second modulation section 1312, and the demodulation section 139 may not be provided in the structure where, in the above description, information data is converted, as a digital pulse signal without modulation/demodulation, into an optical signal and transmitted.

Further, the screen display section 140 superimposes, after imaging, the first information data and (or) the second information data on the screen information (the screen information outputted from two-dimensional storage section 136 in FIG. 14) outputted from the two-dimensional optical-to-electrical conversion section 134 or the two-dimensional storage section 136, and displays the superimposition result on a screen. For example, as shown in FIG. 16, the screen display section 140 displays the contents of the first information data and (or) the second information data by superimposing the contents on the screen information outputted from the two-dimensional optical-to-electrical conversion section 134 or the two-dimensional storage section 136 and by using a representation (“balloon popup”, etc.) associating the contents with the positions (the coordinates A, B) of the images of the first electrical-to-optical conversion section 1331 and (or) the second electrical-to-optical conversion section 1332. Note that although in FIG. 14, two optical transmitters are provided as an example, one optical transmitter or more than two optical transmitters may be provided.

As described above, in the conventional optical space transmission apparatus using, as a photodetector of an optical receiver, a device (an image sensor) having arranged therein a plurality of light-receiving elements in a two-dimensional manner, it is possible to acquire two-dimensional image information (screen information) regarding the space in which an optical transmitter is positioned and also to display information data sent from the optical transmitter in association with the sending position (the position of the optical transmitter on the screen).

However, in the conventional optical space transmission apparatus, the rate (capacity) of the information data is limited due to the speed of reading the pixel information from the image sensor, and thus it is difficult to increase the transmission speed. Specifically, since an image sensor mostly has a structure for reading stored screen information while sequentially scanning the stored screen information on a pixel-by-pixel basis as shown in FIG. 15, the speed of reading (sampling) the pixel information regarding predetermined coordinates is the same as the speed of scanning the screen information. Since an image sensor currently in practical use has, generally, a scanning period of approximately 60 Hz (several hundred Hz at the fastest), the speed of sampling the pixel information is also limited to approximately 60 Hz. That is, the rate of the information data corresponding to the change of the amount of light of each pixel is limited to approximately 30 bps, and thus it is difficult to realize a further increase in speed.

As described above, in the conventional optical space transmission apparatus using the image sensor, while it is possible to provide wireless transmission including a unique user interface for displaying the content of transmitted information in association with the spatial position of the transmission source, it is difficult to realize an increase in speed, due to the limitations of the performance and structure of the image sensor. Further, to respond to an increase in speed, an image sensor for exclusive use is specially prepared to increase the scanning speed, to include a structure for simultaneously reading all of the pixel information, and the like. As a result, it is likely that the cost of the device is increased and thus the economic efficiency is reduced.

### SUMMARY OF THE INVENTION

Therefore, an object of the present invention is to provide an optical space transmission apparatus capable of, when the acquisition of two-dimensional image information and the reception of information data are concurrently performed, realizing an increase in capacity/an increase in speed of the information data, using a general image sensor.

The present invention is directed to an optical space transmission method performed between an optical transmitter and an optical receiver. To attain the above-mentioned object, in the optical space transmission method, the optical transmitter: causes a first light source to emit a predetermined piece of identification information as an optical signal into free space; and causes a second light source to modulate a piece of information data in a modulation type corresponding to the piece of identification information and to emit the modulated piece of information data as an optical signal into free space, and the optical receiver: acquires two-dimensional image information including an image of the first light source, and also reproduces the piece of identification information by detecting, in the two-dimensional image information, a change over time of pixel information corresponding to the first light source; and receives the optical signal outputted from the second light source, demodulates the optical signal in the demodulation type corresponding to the piece of identification information, and reproduces the piece of information data. Based on the above-described method, it is possible, using identification information, to extract and reproduce high-speed information data corresponding to an optical signal included in two-dimensional image information.

When a plurality of light source pairs each including the first light source and the second light source are provided in free space, the pieces of identification information different from each other and the pieces of information data modulated in modulation types corresponding to the respective pieces of identification information and different from each other are emitted into free space. Based on the above-described method, it is possible to independently separate and reproduce a plurality of pieces of information data corresponding to a plurality of optical signals included in two-dimensional image information.

It is preferable that the optical receiver displays the piece of information data by superimposing the piece of information data on the two-dimensional image information including the image of the first light source. Based on the above-described method, it is possible to realize a unique user interface for representing two-dimensional image information and the content of information data corresponding to the two-dimensional image information on the same screen.

In another optical space transmission method of the present invention, the optical transmitter causes a light source to multiplex predetermined identification information with information data modulated in a modulation type corresponding to the identification information and to emit the multiplexing result as an optical signal into free space, and the optical receiver: acquires two-dimensional image information including an image of the light source, detects, in the two-dimensional image information, a change over time of pixel information corresponding to the light source, and reproduces the identification information; and receives the optical signal outputted from the light source, demodulates the optical signal in a demodulation type corresponding to the identification information, and reproduces the information data. Based on the above-described method, it is possible to transmit identification information and information data, using one light source.

Additionally, the present invention is directed to an optical space transmission apparatus including an optical transmitter and an optical receiver. To attain the above-mentioned object, in the optical space transmission apparatus of the present invention, the optical transmitter includes: an optical identification signal generation section operable to receive identification information, operable to electrical-to-optical-convert the identification information, and operable to emit the identification information as an optical identification signal into free space; a modulation section operable to receive information data, operable to modulate the information data in a modulation type corresponding to the identification information, and operable to output the modulated information data; and an optical data signal generation section operable to receive the modulated information data outputted from the modulation section, operable to electrical-to-optical-convert the modulated information data, and operable to emit the converted information data as an optical data signal into free space, and the optical receiver includes: a two-dimensional optical-to-electrical conversion section operable to receive two-dimensional image information having a plurality of pieces of pixel information which include an image of the optical identification signal emitted from the optical identification signal generation section, and operable to acquire the two-dimensional image information as screen information in an electrical signal form; a two-dimensional storage section operable to, at predetermined time intervals, storing thereinto the screen information acquired by the two-dimensional optical-to-electrical conversion section; a coordinate specification section operable to output coordinate information for specifying each pixel of the screen information stored in the two-dimensional storage section; an information reading section operable to read a piece of pixel information from the two-dimensional storage section as needed in accordance with predetermined coordinate information outputted from the coordinate specification section, and operable to reproduce the identification information; an optical-to-electrical conversion section operable to receive the optical data signal emitted from the optical data signal generation section, and operable to acquire the modulated information data by optical-to-electrical-converting the optical data signal; and a demodulation section operable to demodulate, in a demodulation type corresponding to the identification information, the modulated information data outputted from the optical-to-electrical conversion section, and operable to reproduce the information data. Based on the above-described apparatus, it is possible, using identification information, to extract and reproduce high-speed information data corresponding to an optical signal included in two-dimensional image information.

When a plurality of optical transmitters are included, a piece of identification information and a modulation/demodulation type which are used by each optical transmitter may be different from other pieces of identification information and other modulation/demodulation types, respectively. Based on the above-described apparatus, it is possible, of a plurality of pieces of information data corresponding to a plurality of optical signals included in two-dimensional image information, to extract and reproduce an arbitrary piece of information data. In this case, the same number of the demodulation sections as the plurality of optical transmitters may be included, and the demodulation sections may demodulate, in demodulation types corresponding to the respective plurality of the pieces of identification information and different from each other, the plurality of the modulated pieces of information data outputted from the optical-to-electrical conversion section, and may reproduce the plurality of the pieces of information data, separately. Based on the above-described apparatus, it is possible to independently separate and reproduce a plurality of pieces of information data corresponding to a plurality of optical signals included in two-dimensional image information.

It is preferable that the modulation type in which the modulation section performs the modulation is a code division multiplex type which uses a code determined in accordance with the piece of identification information and unique to each of the plurality of optical transmitters, or which is based directly on the piece of identification information. Based on the above-described apparatus, it is possible to multiplex a plurality of pieces of information data corresponding to a plurality of optical signals included in two-dimensional image information into the same frequency domain or the same time domain, and it is also possible to independently separate and reproduce the plurality of pieces of information data. Consequently, it is possible to ensure the confidentiality of information among different receivers. Further, the modulation type in which the modulation section performs the modulation is a frequency multiplex type which uses a carrier frequency determined in accordance with the piece of identification information and unique to each of the plurality of optical transmitters, or is a time division multiplex type which uses a time slot determined in accordance with the piece of identification information and uniquely assigned to each of the plurality of optical transmitters. Based on the above-described apparatus, it is possible to transmit information data in accordance with the characteristics of a transmission line, a transmission method, and the like.

It is preferable that the two-dimensional optical-to-electrical conversion section and the optical-to-electrical conversion section are positioned to have the approximately same light-receiving direction. Based on the above-described apparatus, it is possible to more accurately reproduce information data corresponding to an optical signal included in two-dimensional image information. Further, it is also possible that the two-dimensional optical-to-electrical conversion section and the optical-to-electrical conversion section share the whole or part of an optics system used for input light, cause transmitted light to branch, and each receive the branching light. Based on the above-described apparatus, it is possible to more accurately reproduce information data corresponding to an optical signal included in two-dimensional image information, and it is also possible to reduce the number of the optical components of a receiver.

Additionally, a screen display section operable to receive the screen information outputted from the two-dimensional optical-to-electrical conversion section, and operable to display the screen information on a screen and also to display, with the image of the corresponding optical identification signal, the information data outputted from the demodulation section, may be further included. Based on the above-described apparatus, it is possible to realize a unique user interface for representing two-dimensional image information and the content of information data corresponding to the two-dimensional image information on the same screen.

Additionally, it is preferable that an imaging range which is an area of the screen information acquired by and outputted from the two-dimensional optical-to-electrical conversion section is approximately the same as or smaller than a light-receiving range of the optical-to-electrical conversion section. Based on the above-described apparatus, it is possible to more accurately reproduce information data corresponding to an optical signal included in two-dimensional image information. Further, it is possible to acquire the information data outside the area of the two-dimensional image information. It is preferable that when the imaging range of the two-dimensional optical-to-electrical conversion section is smaller than the light-receiving range of the optical-to-electrical conversion section, presence of the optical transmitter positioned outside the imaging range of the two-dimensional optical-to-electrical conversion section and also positioned within the light-receiving range of the optical-to-electrical conversion section is displayed on a screen displayed by the screen display section. Based on the above-described apparatus, it is possible to realize an excellent user interface for representing two-dimensional image information and the content of information data corresponding to the two-dimensional image information on the same screen, and also for indicating the presence or absence of the information data in the neighboring area outside the two-dimensional image information.

Typically, the optical identification signal is visible light, and the optical data signal is infrared light. Based on the above-described apparatus, it is possible to realize an excellent user interface for visually demonstrating to the user the presence and the position of the source of information data, and it is also possible to transmit the information data at a higher speed.

Typically, the two-dimensional optical-to-electrical conversion section is an image sensor, and the optical-to-electrical conversion section is a photo diode or an avalanche photo diode. Based on the above-described apparatus, it is possible to economically realize a user interface for representing two-dimensional image information and the content of information data corresponding to the two-dimensional image information on the same screen, using an image sensor, such as a CCD and a CMOS device, each of which is used in a digital camera, a camcorder, and the like.

Additionally, in another optical space transmission apparatus of the present invention, the optical transmitter includes: a modulation section operable to receive information data, operable to modulate the information data in a modulation type corresponding to identification information, and operable to output the modulated information data; and an optical signal generation section operable to multiplex, in a predetermined multiplex method, the identification information with the modulated information data outputted from the modulation section, and operable to emit an optical signal acquired by electrical-to-optical-converting the multiplexing result, into free space, and the optical receiver includes: a two-dimensional optical-to-electrical conversion section operable to receive two-dimensional image information having a plurality of pieces of pixel information which include an image of the optical signal emitted from the optical signal generation section, and operable to acquire the two-dimensional image information as screen information in an electrical signal form; a two-dimensional storage section operable to, at predetermined time intervals, storing thereinto the screen information acquired by the two-dimensional optical-to-electrical conversion section; a coordinate specification section operable to output coordinate information for specifying each pixel of the screen information stored in the two-dimensional storage section; an information reading section operable to read a piece of pixel information from the two-dimensional storage section as needed in accordance with predetermined coordinate information outputted from the coordinate specification section, and operable to extract and reproduce the identification information; an optical-to-electrical conversion section operable to receive the optical signal emitted from the optical signal generation section, and operable to acquire the multiplexing result by optical-to-electrical-converting the optical signal; and a demodulation section operable to extract the modulated information data from the multiplexing result outputted from the optical-to-electrical conversion section, operable to demodulate the extracted modulated information data in a demodulation type corresponding to the identification information, and operable to reproduce the information data. Based on the above-described apparatus, it is possible to transmit identification information and information data, using one light source.

Note that it is preferable that the predetermined multiplex method is a method for frequency-division-multiplexing the identification information into a low-frequency side of the modulated information data. Based on the above-described apparatus, it is possible, in a two-dimensional optical-to-electrical conversion section, to receive identification information of a low-frequency area, and it is also possible to transmit information data at a high speed, using a high-frequency area.

Based on the present invention, it is possible to provide an optical space transmission apparatus capable of, when the acquisition of two-dimensional image information and the reception of information data are concurrently performed, realizing an increase in capacity/an increase in speed of the information data, using a general image sensor.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing a structure of an optical space transmission apparatus according to a first embodiment of the present invention;

FIG. 2 is a schematic diagram illustrating a manner of screen information displayed by a screen display section 110;

FIGS. 3A and 3B are a schematic diagram illustrating example positions of a two-dimensional optical-to-electrical conversion section 104 and an optical-to-electrical conversion section 105;

FIG. 4 is a block diagram showing an example structure of an optics system of an optical receiver 1003;

FIG. 5 is a diagram showing another structure of the optical space transmission apparatus according to the first embodiment of the present invention;

FIG. 6 is a schematic diagram illustrating a manner of screen information displayed by the screen display section 510;

FIG. 7 is a schematic diagram illustrating the optics characteristics of the two-dimensional optical-to-electrical conversion section 104 and the optical-to-electrical conversion section 105;

FIG. 8 is a schematic diagram illustrating another manner of the screen information displayed by the screen display section 510;

FIG. 9 is a diagram showing yet another structure of the optical space transmission apparatus according to the first embodiment of the present invention;

FIG. 10 is a diagram showing a structure of an optical space transmission apparatus according to a second embodiment of the present invention;

FIG. 11 is a schematic diagram illustrating a multiplex type of an identification signal and a modulated signal (information data) in the second embodiment of the present invention;

FIG. 12 is a diagram showing another structure of the optical space transmission apparatus according to the second embodiment of the present invention;

FIG. 13 is a diagram showing yet another structure of the optical space transmission apparatus according to the second embodiment of the present invention;

FIG. 14 is a diagram showing a structure of a conventional optical space transmission apparatus;

FIG. 15 is a schematic diagram illustrating a manner of screen information displayed by a screen display section of the conventional optical space transmission apparatus;

FIG. 16 is a schematic diagram illustrating an acquisition procedure of modulated signals (information data) which is performed by a two-dimensional optical-to-electrical conversion section of the conventional optical space transmission apparatus; and

FIG. 17 is a schematic diagram illustrating the principle and the response speed of the two-dimensional optical-to-electrical conversion section of the conventional optical space transmission apparatus.

### DESCRIPTION OF THE PREFERRED EMBODIMENTS

### First Embodiment

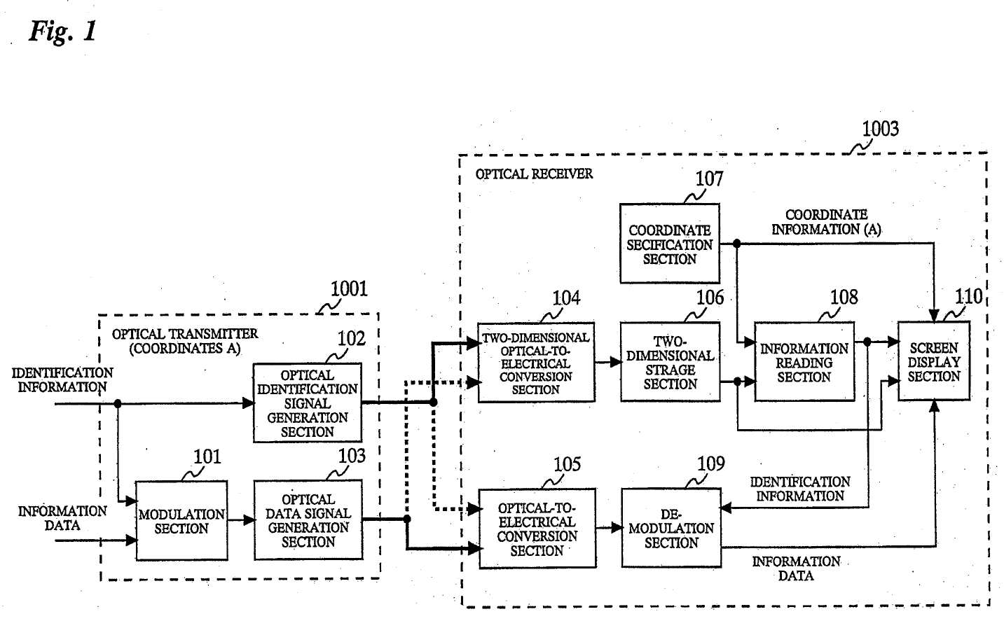

With reference to FIG. 1, a structure of an optical space transmission apparatus according to a first embodiment of the present invention will be described below. Referring to FIG. 1, the optical space transmission apparatus of the present embodiment includes a modulation section 101, an optical identification signal generation section 102, an optical data signal generation section 103, a two-dimensional optical-to-electrical conversion section 104, an optical-to-electrical conversion section 105, a two-dimensional storage section 106, a coordinate specification section 107, an information reading section 108, a demodulation section 109, and a screen display section 110. An optical transmitter 1001 includes the modulation section 101, the optical identification signal generation section 102, and the optical data signal generation section 103. An optical receiver 1003 includes the two-dimensional optical-to-electrical conversion section 104, the optical-to-electrical conversion section 105, the two-dimensional storage section 106, the coordinate specification section 107, the information reading section 108, the demodulation section 109, and the screen display section 110.

Next, the operation of the present embodiment shown in FIG. 1 will be described. Identification information unique to the optical transmitter 1001 is assigned thereto in advance. The optical identification signal generation section 102 electrical-to-optical-converts the identification information assigned to the optical transmitter 1001 and emits the converted identification information as an optical identification signal into free space. The modulation section 101 receives information data and modulates the information data in a predetermined modulation type determined based on the identification information. The optical data signal generation section 103 electrical-to-optical-converts the modulated information data outputted from the modulation section 101 and emits the converted information data as an optical data signal into free space.

The two-dimensional optical-to-electrical conversion section 104 receives the optical identification signal outputted from the optical identification signal generation section 102. Additionally, the two-dimensional optical-to-electrical conversion section 104 acquires two-dimensional image information including the optical transmitter 1001 (or the optical identification signal generation section 102) and outputs the two-dimensional image information as screen information (an electrical signal). The two-dimensional storage section 106, at predetermined time intervals, stores thereinto and updates the screen information outputted from the two-dimensional optical-to-electrical conversion section 104. The coordinate specification section 107 outputs coordinate information which specifies the position of the pixel in which the image of the optical identification signal (or the optical identification signal generation section 102) is present, with respect to the screen information stored in the two-dimensional storage section 106. In accordance with the coordinate information outputted from the coordinate specification section 107, the information reading section 108 reads pixel information regarding predetermined coordinates as needed from the screen information stored in the two-dimensional storage section 106, and reproduces the identification information assigned to the optical transmitter 1001.

The optical-to-electrical conversion section 105 receives the optical data signal outputted from the optical data signal generation section 103, and acquires the modulated information data by converting the optical data signal into an electrical signal. The demodulation section 109 receives the modulated information data outputted from the optical-to-electrical conversion section 105, demodulates the modulated information data in accordance with a predetermined demodulation type determined based on the identification information reproduced by the information reading section 108, and reproduces the information data received by the modulation section 101.

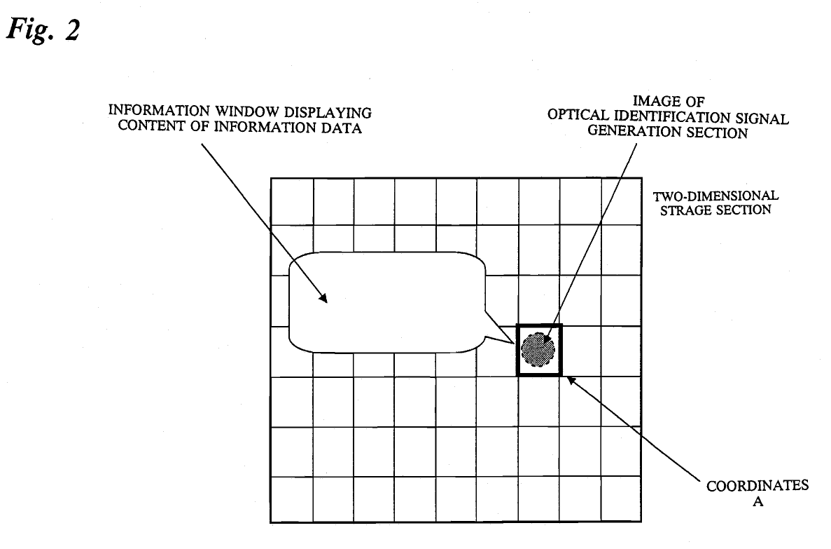

The screen display section 110, as needed, displays and updates the screen information stored in the two-dimensional storage section 106. Additionally, based on the identification information outputted from the information reading section 108, the screen display section 110 displays, in a predetermined manner, the content of the information data outputted from the demodulation section 109, in association with the pixel corresponding to the coordinates specified by the coordinate specification section 107. For example, referring to FIG. 2, on the screen information outputted from the two-dimensional storage section 106, the content of the information data is superimposed in a “balloon popup” manner in association with coordinates A corresponding to the image of the optical identification signal.

The predetermined modulation type in which the modulation section 101 performs the modulation based on the identification information and the predetermined demodulation type in which the demodulation section 109 performs the demodulation based on the identification information may be, for example, a coding type using a predetermined code corresponding to the identification information, a carrier modulation type using a predetermined carrier frequency, or a pulse signal type in which a predetermined time slot is assigned.

As a light source used for the optical identification signal generation section 102, a visible light source as typified by a fluorescent light, a white light-emitting diode, and the like may be used. As a light source used for the optical data signal generation section 103, a light source having high broadband performance, e.g., an invisible light source as typified by a red light-emitting diode, an infrared laser, and the like, may be used. Note that the light source used for the optical data signal generation section 103 may be a visible light source if capable of performing a faster modulation than that performed by the light source used for the optical identification signal generation section 102. Further, as the two-dimensional optical-to-electrical conversion section 104, an image sensor such as a CCD and a CMOS device may be used. As the optical-to-electrical conversion section 105, a photo diode (PD), an avalanche photo diode (APD), and the like, each of which has high broadband performance and is capable of detecting a high-speed-optical-modulated signal, may be used.

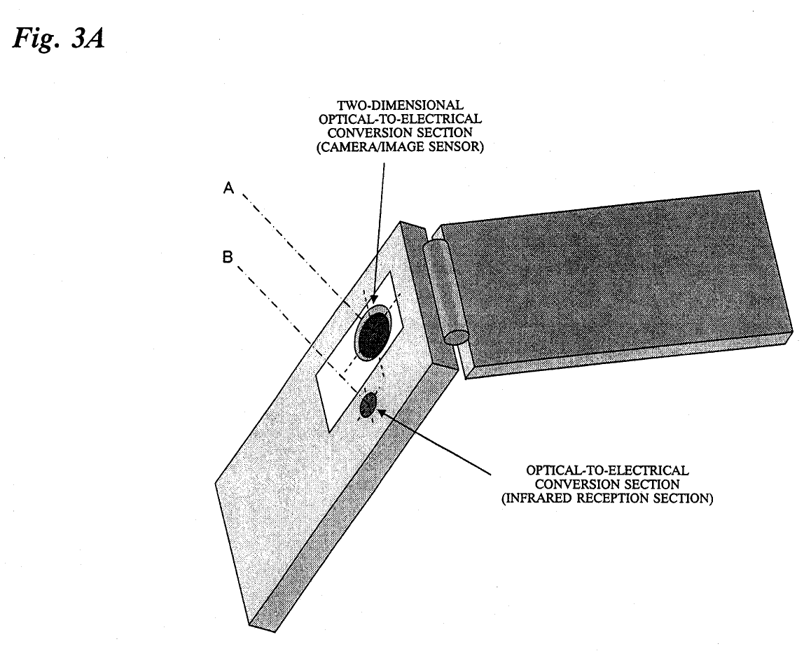

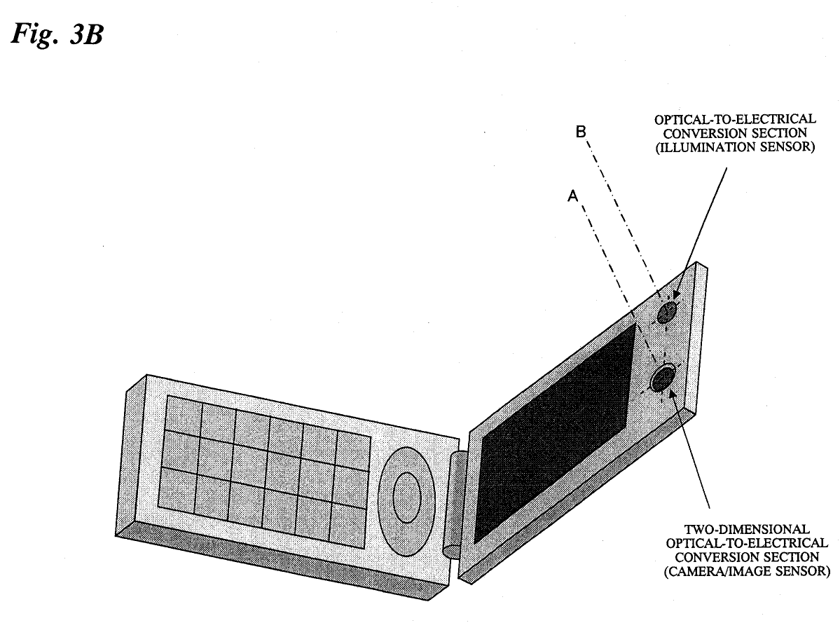

In the present embodiment, on the screen information acquired by the two-dimensional optical-to-electrical conversion section 104 and displayed by the screen display section 110, the information data received by the optical-to-electrical conversion section 105 and reproduced by the demodulation section 109 is displayed by being superimposed. Therefore, as in a mobile phone shown in FIGS. 3A and 3B, the light-receiving surfaces of the two-dimensional optical-to-electrical conversion section 104 (a camera, an image sensor, etc. in FIGS. 3A and 3B) and the optical-to-electrical conversion section 105 (an infrared light reception section in FIG. 3A, an illumination sensor in FIG. 3B, etc.) are both positioned to face in the same direction. Further, to improve the consistency between the screen information and the information data, it is preferable that the imaging range (light-receiving range) of the two-dimensional optical-to-electrical conversion section 104 is set to be the same as the light-receiving range of the optical-to-electrical conversion section 105.

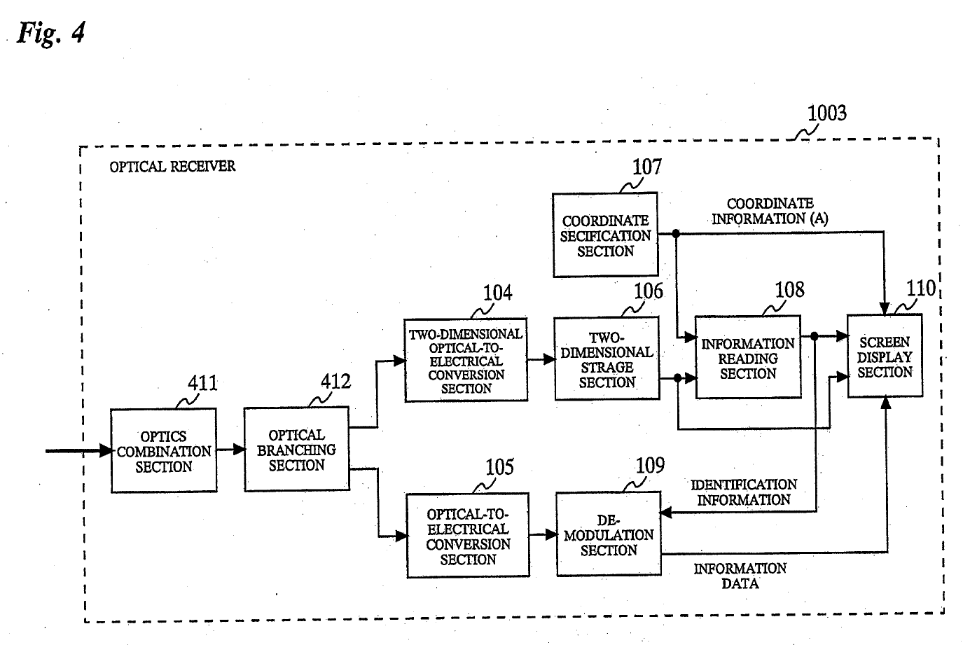

Specifically, as shown in FIG. 4, in the optical receiver 1003, an optics system is shared for making the two-dimensional image information and the optical identification signal incident on the two-dimensional optical-to-electrical conversion section 104 and for making the optical data signal incident on the optical-to-electrical conversion section 105. That is, an optics combination section 411 appropriately performs an optics process, such as light collection, on the optical identification signal, the optical data signal, and the two-dimensional image information, and then an optical branching section 412 causes the output light from the optics combination section 411 to branch and inputs the branching light to the two-dimensional optical-to-electrical conversion section 104 and the optical-to-electrical conversion section 105, correspondingly.

As described above, based on the optical space transmission apparatus according to the first embodiment of the present invention, while identification information unique to an optical transmitter is set and sent as visible light by a light source, information data is transmitted in a modulation/demodulation type uniquely corresponding to the identification information, using a broadband light source which is separately provided, whereby it is possible to provide a display manner of displaying the content of the information data in association with the position of the light source on screen information acquired by an image sensor, and it is also possible to transmit high-speed and large-capacity information data.

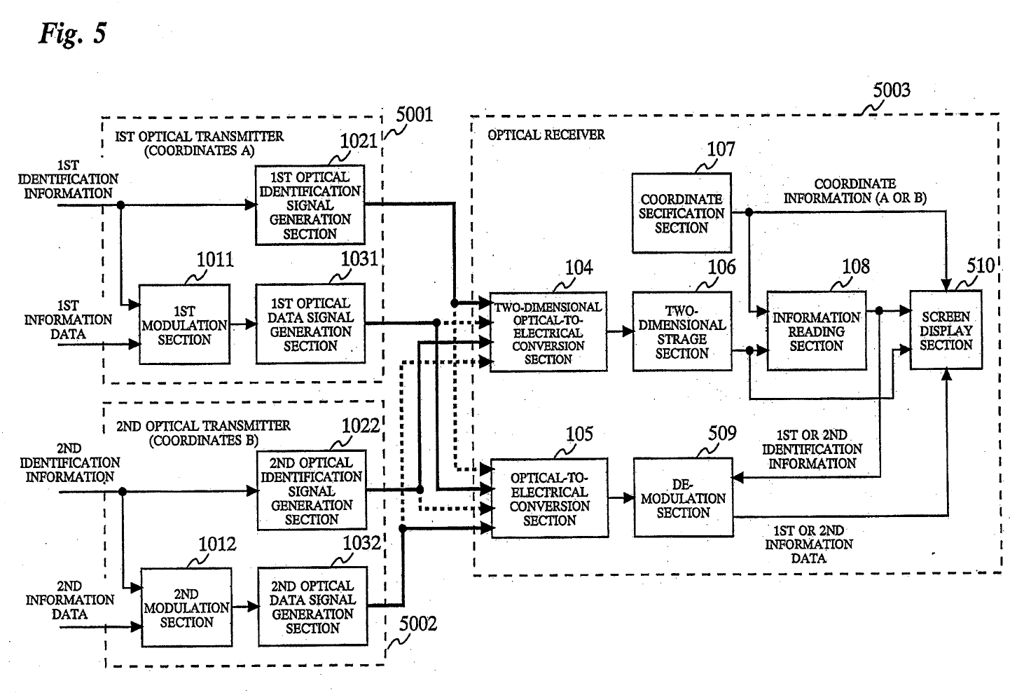

Next, with reference to FIG. 5, another structure of the optical space transmission apparatus according to the present embodiment will be described. In the optical space transmission apparatus shown in FIG. 5, two optical transmitters 1001 of FIG. 1 are provided. A first optical transmitter 5001 includes a first modulation section 1011, a first optical identification signal generation section 1021, and a first optical data signal generation section 1031. Further, a second optical transmitter 5002 includes a second modulation section 1012, a second optical identification signal generation section 1022, and a second optical data signal generation section 1032. An optical receiver 5003 includes a two-dimensional optical-to-electrical conversion section 104, an optical-to-electrical conversion section 105, a two-dimensional storage section 106, a coordinate specification section 107, an information reading section 108, a demodulation section 509, and a screen display section 510.

Referring to FIG. 5, first identification information unique to the first optical transmitter 5001 and second identification information unique to the second optical transmitter 5002, which are different from each other, are assigned thereto in advance, respectively. The first optical identification signal generation section 1021 and the second optical identification signal generation section 1022 electrical-to-optical-convert the first identification information and the second identification information which are different from each other and assigned to the first and second optical transmitters 5001 and 5002, and emit the converted first identification information and the converted second identification information as a first optical identification signal and a second optical identification signal into free space, respectively. The first modulation section 1011 and the second modulation section 1012 receive first information data and second information data, and modulate the first information data and the second information data in predetermined modulation types determined based on the corresponding identification information and different from each other, respectively. The first optical data signal generation section 1031 and the second optical data signal generation section 1032 electrical-to-optical-convert the modulated information data outputted from the first modulation section 1011 and the modulated information data outputted from the second modulation section 1012, and emit the converted information data as a first optical data signal and a second optical data signal into free space, respectively.

The two-dimensional optical-to-electrical conversion section 104 receives the first optical identification signal and the second optical identification signal. Additionally, the two-dimensional optical-to-electrical conversion section 104 acquires two-dimensional image information including the first optical transmitter 5001 (or the first optical identification signal generation section 1021) and the second optical transmitter 5002 (or the second optical identification signal generation section 1022) and outputs the two-dimensional image information as screen information (an electrical signal). The two-dimensional storage section 106, at predetermined time intervals, stores thereinto and updates the screen information outputted from the two-dimensional optical-to-electrical conversion section 104. The coordinate specification section 107 outputs coordinate information which specifies the positions of the pixels in which the images of the first optical identification signal (or the first optical identification signal generation section 1021) and the second optical identification signal (or the second optical identification signal generation section 1022) are present, with respect to the screen information stored in the two-dimensional storage section 106. In accordance with the coordinate information outputted from the coordinate specification section 107, the information reading section 108 reads pixel information regarding predetermined coordinates as needed from the screen information stored in the two-dimensional storage section 106, and reproduces the first identification information and the second identification information.

The optical-to-electrical conversion section 105 receives the first optical data signal and the second optical data signal, and acquires the modulated information data by converting the first and second optical data signals into electrical signals, respectively. The demodulation section 509 receives the modulated information data outputted from the optical-to-electrical conversion section 105, demodulates the modulated information data in accordance with predetermined demodulation types different from each other and determined based on the first identification information and the second identification information which are reproduced by the information reading section 108, and reproduces the first information data and the second information data, respectively. The screen display section 510, as needed, displays and updates the screen information stored in the two-dimensional storage section 106. Additionally, based on the first identification information and the second identification information, the screen display section 510 displays, in a predetermined manner, the contents of the first information data and the second information data, respectively, in association with the pixels corresponding to the coordinates specified by the coordinate specification section 107.

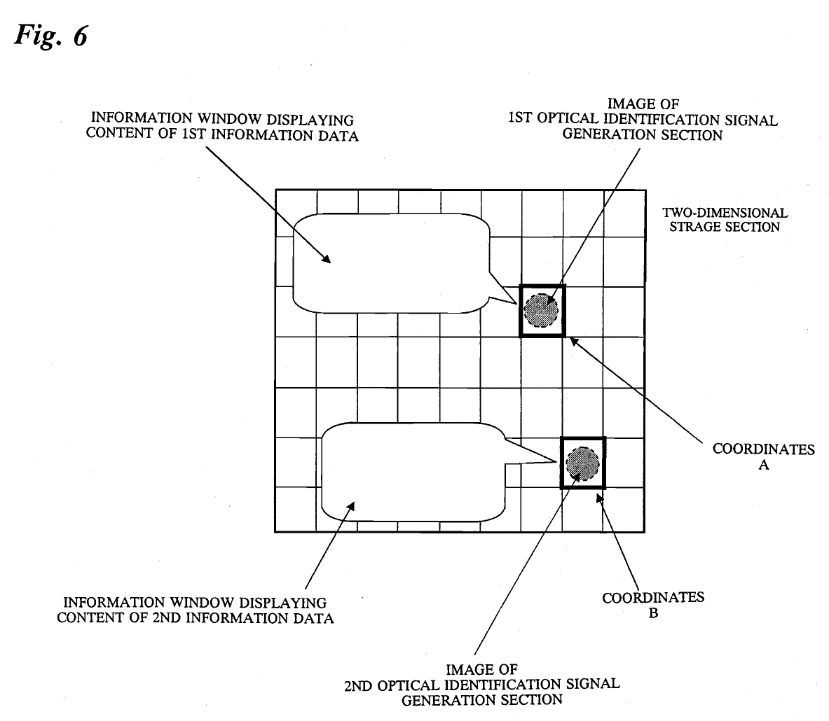

For example, referring to FIG. 6, on the screen information outputted from the two-dimensional storage section 106, the contents of the first information data and the second information data are superimposed in a “balloon popup” manner, in association with coordinates A corresponding to the image of the first optical identification signal and coordinates B corresponding to the image of the second optical identification signal, respectively. Although two optical transmitters are provided as an example in FIG. 5, more than two optical transmitters may be provided. In this case, the same number of pieces of identification information different from each other and the same number of modulation/demodulation types different from each other as the optical transmitters may be provided.

The predetermined modulation types different from each other, in which the first modulation section 1011 and the second modulation section 1012 perform the modulations based on the first identification information and the second identification information, respectively, and the predetermined demodulation types different from each other, in which the demodulation section 509 performs the demodulations based on the first identification information and the second identification information, may be a code division multiplex type using codes different between the first identification information and the second identification information, a frequency multiplex type using carrier frequencies different between the first identification information and the second identification information, or a time division multiplex type in which time slots different between the first identification information and the second identification information are assigned. Consequently, even when the optical-to-electrical conversion section 105 concurrently receives a plurality of optical data signals, it is possible, using pieces of identification information different from each other, to demultiplex and extract the plurality of optical data signals, separately.

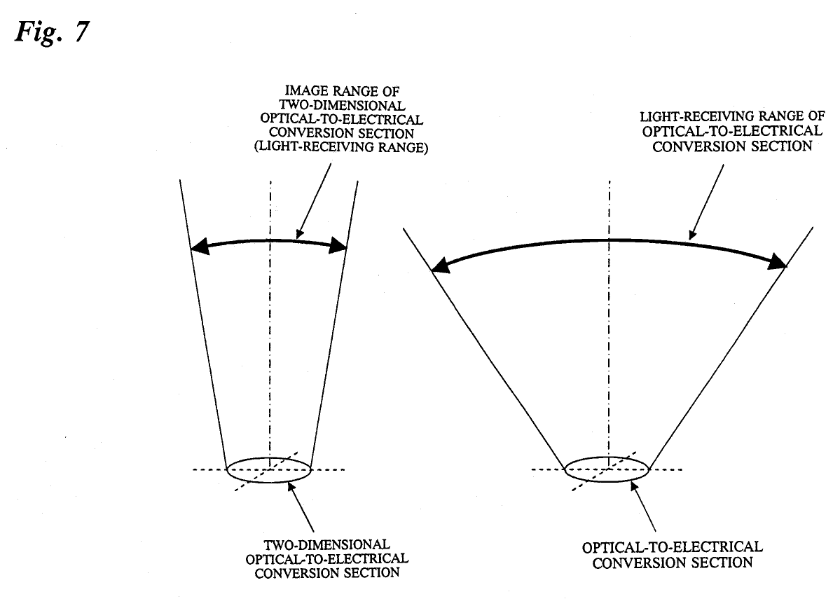

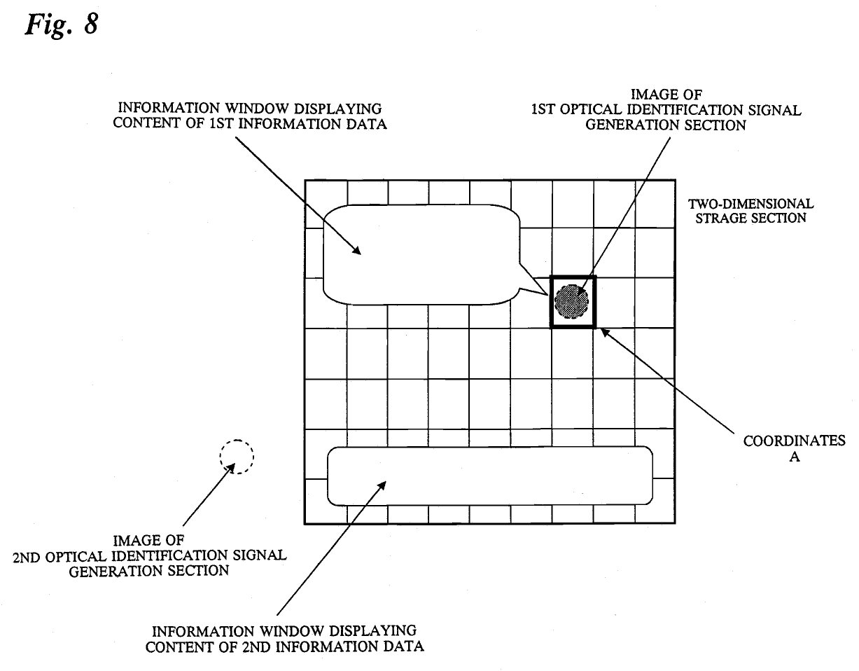

In the present embodiment, on the screen information acquired by the two-dimensional optical-to-electrical conversion section 104 and displayed by the screen display section 510, the first information data and the second information data which are received by the optical-to-electrical conversion section 105 and reproduced by the demodulation section 509 are displayed by being accurately superimposed. Therefore, it is preferable that the imaging range (light-receiving range) of the two-dimensional optical-to-electrical conversion section 104 is set to be the same as the light-receiving range of the optical-to-electrical conversion section 105. Further, in the case where, as shown in FIG. 7, the light-receiving range of the optical-to-electrical conversion section 105 is wider than the imaging range of the two-dimensional optical-to-electrical conversion section 104, when the information data is received by the optical-to-electrical conversion section 105 but sent from the optical transmitter of which the image is not acquired by the two-dimensional optical-to-electrical conversion section 104, as shown in FIG. 8, the content of the information data (the second information data in FIG. 8) is displayed in such a manner that the content is not associated with predetermined coordinates on the screen.

As described above, based on said another structure of the optical space transmission apparatus, while pieces of identification information unique to a plurality of optical transmitters are set and sent as visible light by light sources separately, pieces of information data are transmitted in modulation/demodulation types uniquely corresponding to the pieces of identification information and different from each other, whereby it is possible to provide a display manner of displaying the contents of a plurality of the pieces of information data in association with the positions of a plurality of the light sources on screen information acquired by an image sensor, and it is also possible to transmit high-speed and large-capacity information data.

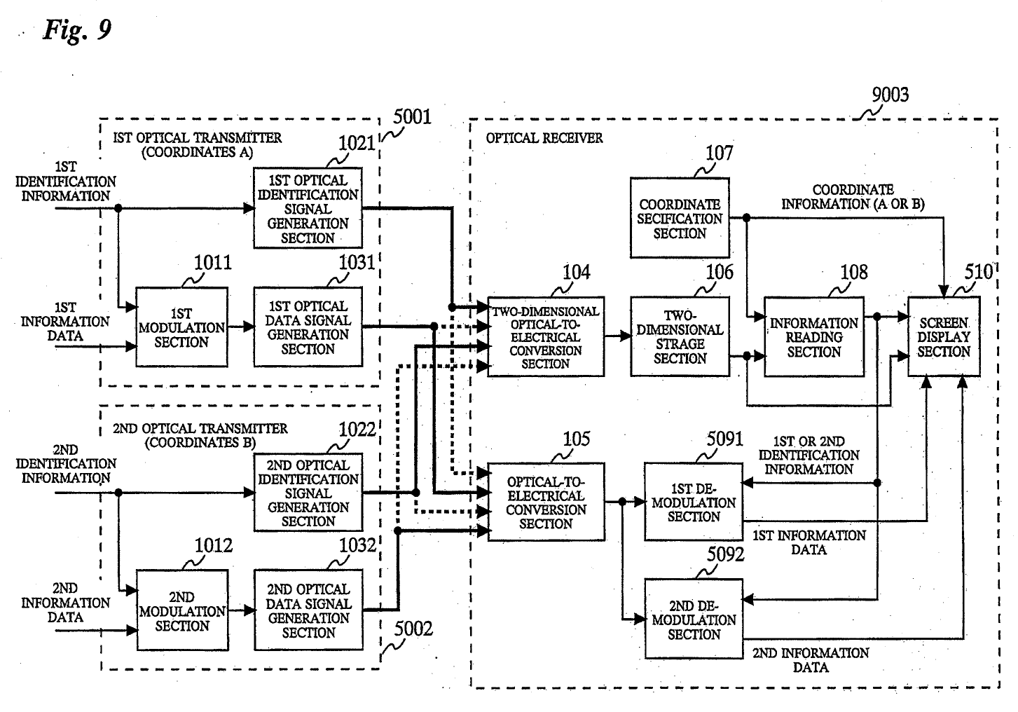

Next, with reference to FIG. 9, yet another structure of the optical space transmission apparatus according to the present embodiment will be described. In the optical space transmission apparatus shown in FIG. 9, two demodulation sections 509 of FIG. 5 are provided. An optical receiver 9003 includes a two-dimensional optical-to-electrical conversion section 104, an optical-to-electrical conversion section 105, a two-dimensional storage section 106, a coordinate specification section 107, an information reading section 108, a first demodulation section 5091, a second demodulation section 5092, and a screen display section 510.

Referring to FIG. 9, the optical-to-electrical conversion section 105 receives the first optical data signal and the second optical data signal, and acquires the modulated information data by modulating the first and second optical data signals into electrical signals, respectively. The first demodulation section 5091 and the second demodulation section 5092 receive the modulated information data outputted from the optical-to-electrical conversion section 105, demodulate the modulated information data in accordance with predetermined demodulation types different from each other and determined based on the first identification information and the second identification information which are reproduced by the information reading section 108, and reproduce the first information data and the second information data, respectively. The screen display section 510, as needed, displays and updates the screen information stored in the two-dimensional storage section 106. Additionally, based on the first identification information and the second identification information, the screen display section 510 displays, in a predetermined manner, the contents of the first information data and the second information data, respectively, in association with the pixels corresponding to the coordinates specified by the coordinate specification section 107.

As described above, based on the first embodiment of the present invention, in an optical space transmission apparatus for acquiring screen information regarding the space in which an optical transmitter is positioned, and for displaying the content of information data sent from the optical transmitter in association with the image of the optical transmitter, the information data and an identification signal are associated with each other. Further, a visible light source of an optical identification signal generation section for allowing the image of the optical transmitter to be recognized as the screen information is separated from a light source of an optical data signal generation section for sending the information data, and thus large-capacity information data is transmitted by a broadband light source, regardless of the modulatable bandwidth of the visible light source. Consequently, it is possible to provide an optical space transmission apparatus balancing an excellent user interface using screen information with high-speed and large-capacity data transmission performance.

Note that it is preferable that the optical identification signal and the optical data signal are emitted approximately parallel to each other from the optical transmitters 1001, 5001 and 5002 to the optical receivers 1003, 5003 and 9003, respectively. Therefore, it is preferable that the optical identification signal generation sections 102, 1021 and 1022, and the optical data signal generation section 103, 1031 and 1032 are positioned at the same position or positioned adjacent to each other, respectively.

### Second Embodiment

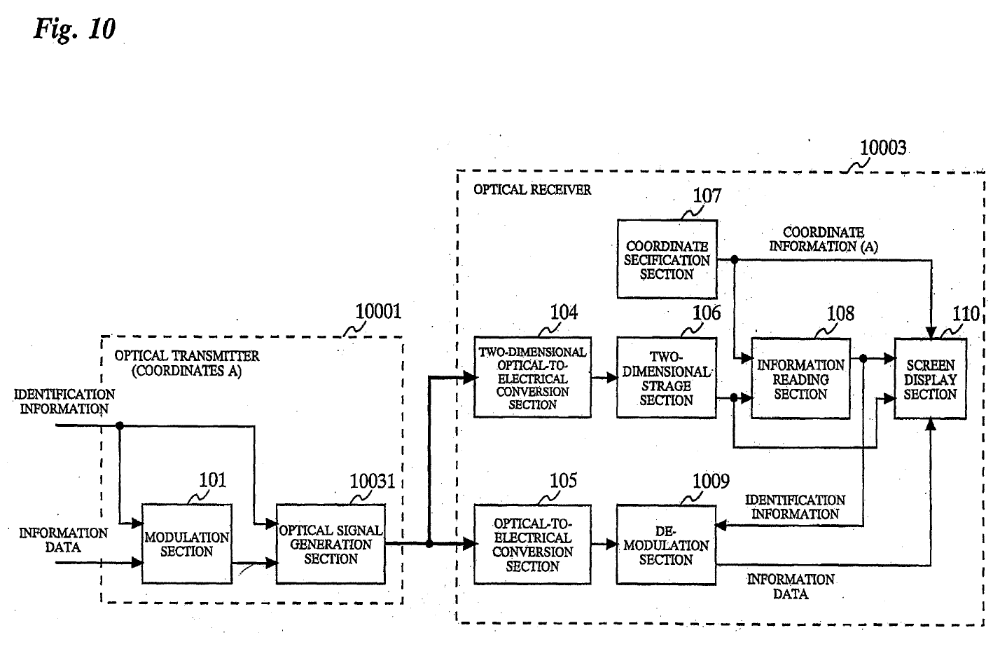

With reference to FIG. 10, an optical space transmission apparatus according to a second embodiment of the present invention will be described. Referring to FIG. 10, the optical space transmission apparatus of the present embodiment includes a modulation section 101, an optical signal generation section 10031, a two-dimensional optical-to-electrical conversion section 104, an optical-to-electrical conversion section 105, a two-dimensional storage section 106, a coordinate specification section 107, an information reading section 108, a demodulation section 1009, and a screen display section 110. An optical transmitter 10001 includes the modulation section 101 and the optical signal generation section 10031. An optical receiver 10003 includes the two-dimensional optical-to-electrical conversion section 104, the optical-to-electrical conversion section 105, the two-dimensional storage section 106, the coordinate specification section 107, the information reading section 108, the demodulation section 1009, and the screen display section 110. The structure of FIG. 10 is different from that of the FIG. 1 in that the optical signal generation section 10031 is provided in FIG. 10 in place of the optical identification signal generation section 102 and the optical data signal generation section 103 of FIG. 1.

Next, the operation of the present embodiment shown in FIG. 10 will be described. Since the structure of the present embodiment is similar to that of the first embodiment (FIG. 1), only the differences therebetween will be described while blocks performing the same operations will be denoted by the same numerals and will not be described. In the optical space transmission apparatus of the present embodiment shown in FIG. 10, the optical signal generation section 10031 receives the identification information and the modulated information data outputted from the modulation section 101, multiplexes the identification information with the modulated information data in a predetermined procedure, electrical-to-optical-converts the multiplexing result, and emits the conversion result as an optical signal into free space.

The two-dimensional optical-to-electrical conversion section 104 receives the optical signal outputted from the optical signal generation section 10031. Additionally, the two-dimensional optical-to-electrical conversion section 104 acquires two-dimensional image information including the optical transmitter 10001 (or the optical signal generation section 10031) and outputs the two-dimensional image information as screen information (an electrical signal). The two-dimensional storage section 106, at predetermined time intervals, stores thereinto and updates the screen information outputted from the two-dimensional optical-to-electrical conversion section 104. The coordinate specification section 107 outputs coordinate information which specifies the position of the pixel in which the image of the optical signal (or the optical signal generation section 10031) is present, with respect to the screen information stored in the two-dimensional storage section 106. In accordance with the coordinate information outputted from the coordinate specification section 107, the information reading section 108 reads pixel information regarding predetermined coordinates as needed from the screen information stored in the two-dimensional storage section 106, and reproduces the identification information assigned to the optical transmitter 10001.

The optical-to-electrical conversion section 105 receives the optical signal outputted from the optical signal generation section 10031, converts the optical signal into an electrical signal, and outputs the electrical signal. The demodulation section 1009 receives the electrical signal outputted from the optical-to-electrical conversion section 105, extracts and demultiplexes a signal component corresponding to the modulated information data from the electrical signal in accordance with the predetermined procedure, demodulates the modulated information data in accordance with a predetermined demodulation type determined based on the identification information reproduced by the information reading section 108, and reproduces the information data received by the modulation section 101. The screen display section 110, as needed, displays and updates the screen information stored in the two-dimensional storage section 106. Additionally, based on the identification information outputted from the information reading section 108, the screen display section 110 displays, in a predetermined manner, the content of the information data outputted from the demodulation section 1009, in association with the pixel corresponding to the coordinates specified by the coordinate specification section 107.

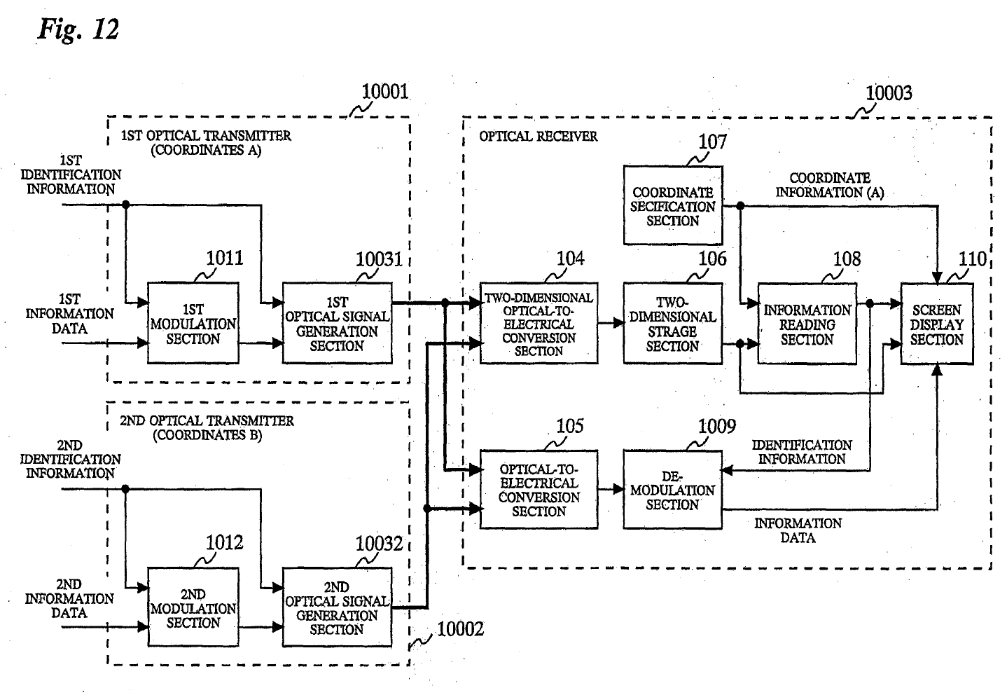

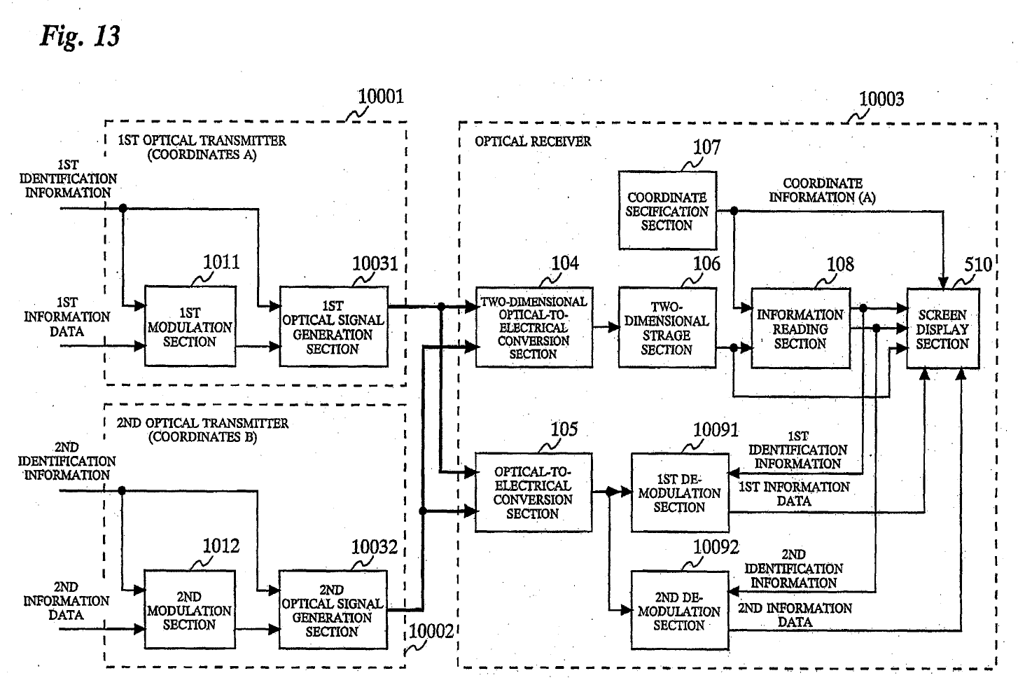

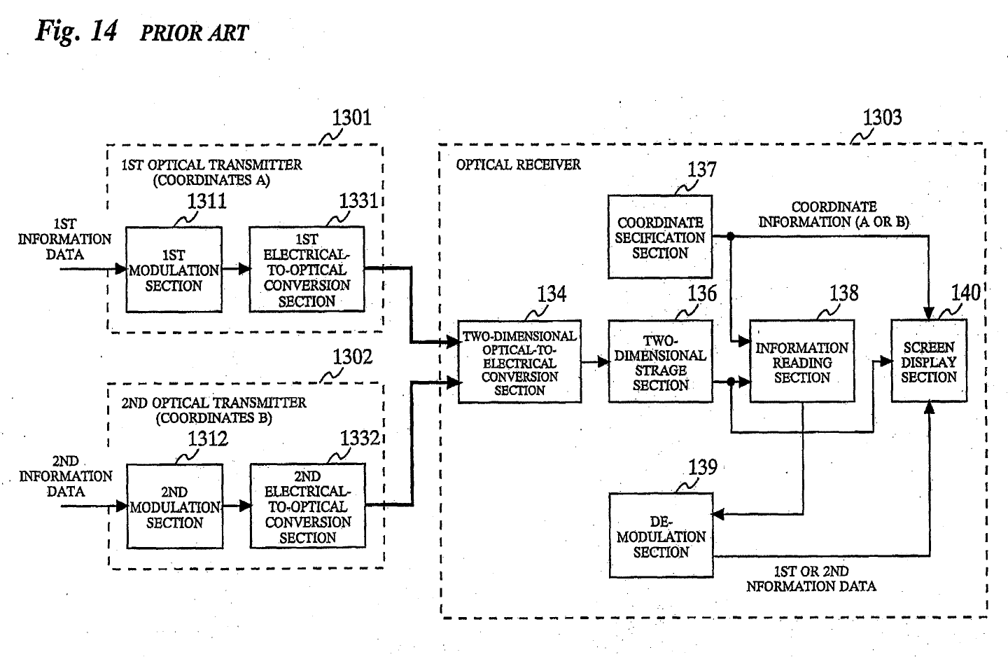

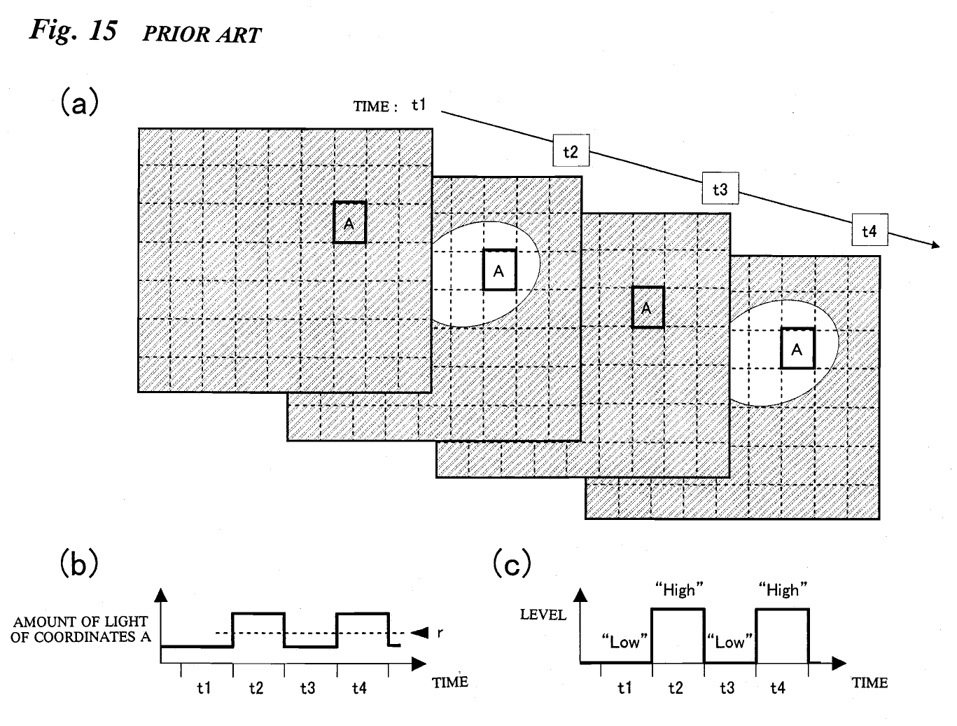

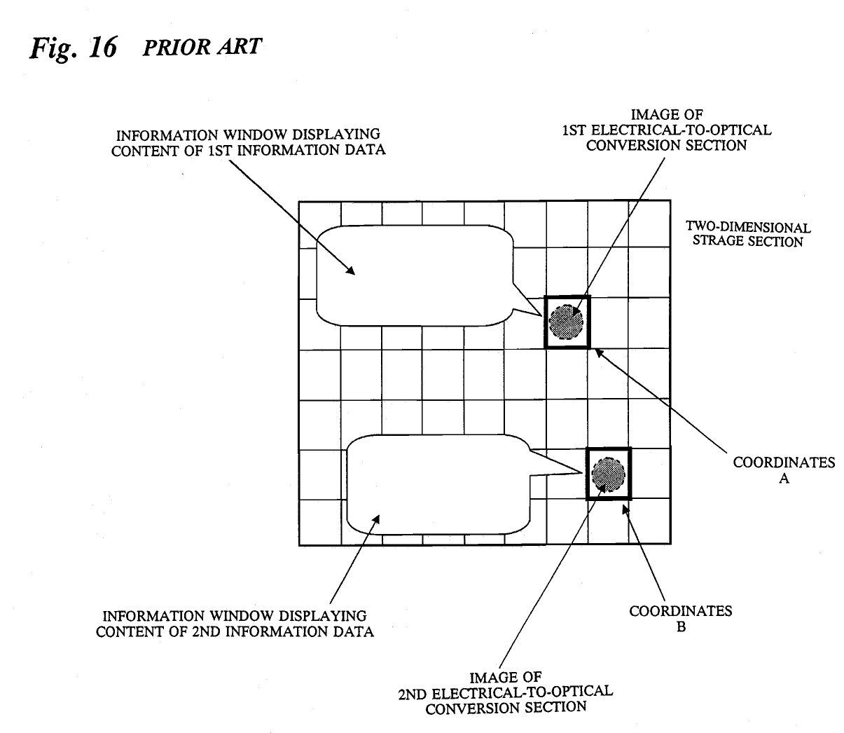

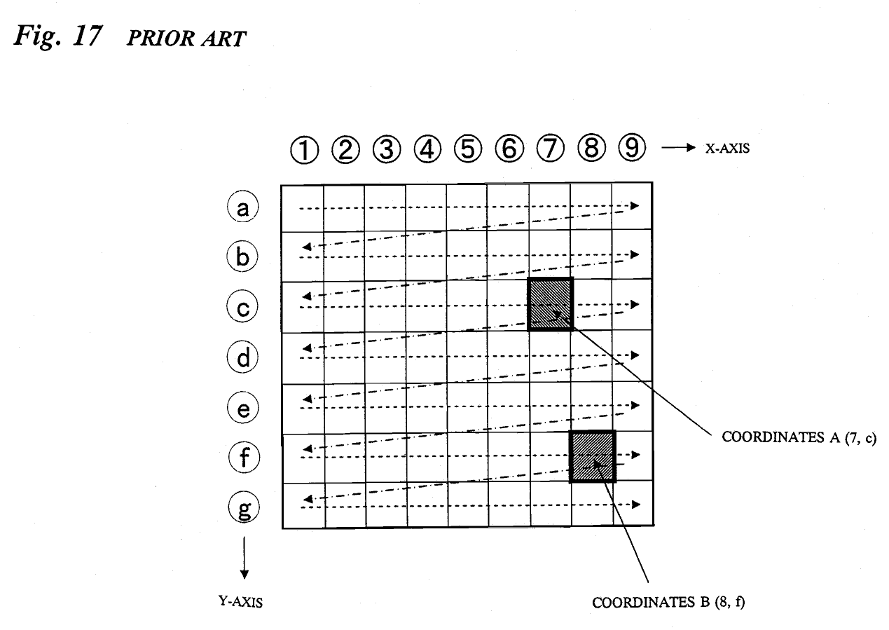

Note that as has been described in FIG. 5 of the first embodiment, a plurality of the optical transmitters 1001 (a first optical transmitter 10001 and a second optical transmitter 10002 of FIG. 12) may be used. Further, as has been described in FIG. 9 of the first embodiment, a plurality of the demodulation sections 1009 (a first demodulation section 10091 and a second demodulation section 10092 of FIG. 13) may be used in accordance with the number of the optical transmitters (a first optical transmitter 10001 and a second optical transmitter 10002 of FIG. 13).

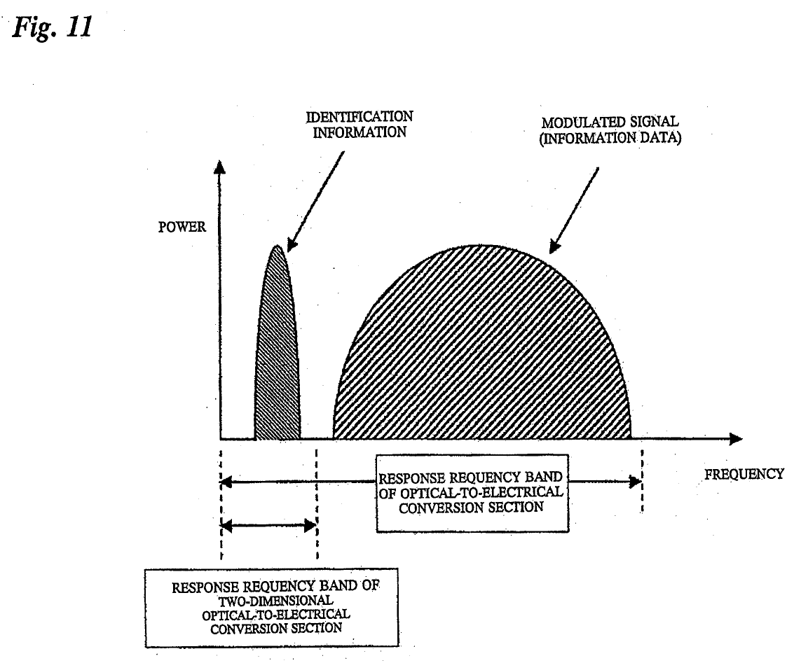

The predetermined procedure in which the optical signal generation section 10031 multiplexes the identification information with the modulated signal based on the information data, and the predetermined procedure in which the demodulation section 1009 demultiplexes the modulated signal, may be a frequency multiplex method in which the multiplexing/demultiplexing is performed in a frequency manner by positioning the identification information on the low-frequency side corresponding to the response frequency band of the two-dimensional optical-to-electrical conversion section and by positioning the modulated signal on the high-frequency side within the response frequency band of the optical-to-electrical conversion section. FIG. 11 is a diagram illustrating the above-described frequency multiplex method.

As a light source used for the optical signal generation section 10031, a visible light source having high broadband performance, such as a white light-emitting diode combining red (R)/green (G)/blue (B) light-emitting elements, may be used. Further, as the two-dimensional optical-to-electrical conversion section 104, an image sensor such as a CCD and a CMOS device may be used. As the optical-to-electrical conversion section 105, a photo diode (PD), an avalanche photo diode (APD), and the like, each of which has high broadband performance and is capable of detecting a high-speed-optical-modulated signal, may be used.

As described above, based on the second embodiment of the present invention, in an optical space transmission apparatus for acquiring screen information regarding the space in which an optical transmitter is positioned, and for displaying the content of information data sent from the optical transmitter in association with the image of the optical transmitter, the information data and an identification signal are associated with each other and then multiple-transmitted. Then, a two-dimensional optical-to-electrical conversion section for acquiring the screen information including the image of the optical transmitter and also for acquiring the identification signal is separated from an optical-to-electrical conversion section for acquiring the information data, and thus large-capacity information data is transmitted, making use of the broadband performance of the photo diode used for the optical-to-electrical conversion section, virtually without being restricted by the response frequency bandwidth of an image sensor used for the two-dimensional optical-to-electrical conversion section. Consequently, it is possible to provide an optical space transmission apparatus balancing an excellent user interface using screen information with high-speed and large-capacity data transmission performance.

While the invention has been described in detail, the foregoing description is in all aspects illustrative and not restrictive. It is understood that numerous other modifications and variations can be devised without departing from the scope of the invention.

What is claimed is:

1. An optical space transmission method performed between an optical transmitter and an optical receiver,
the optical transmitter:
causing a first light source to emit a predetermined piece of identification information as an optical signal into free space; and
causing a second light source to modulate a piece of information data in a modulation type corresponding to the piece of identification information and to emit the modulated piece of information data as an optical signal into free space, and
the optical receiver:
acquiring two-dimensional image information including an image of the first light source, and also reproducing the piece of identification information by detecting, in the two-dimensional image information, a change over time of pixel information corresponding to the first light source; and
receiving the optical signal outputted from the second light source, demodulating the optical signal in a demodulation type corresponding to the piece of identification information, and reproducing the piece of information data.

2. The optical space transmission method according to claim 1,
wherein a plurality of light source pairs each including the first light source and the second light source are provided in free space,
wherein the plurality of the first light sources emit the pieces of identification information different from each other as optical signals into free space, and
wherein the plurality of the second light sources modulate the pieces of information data different from each other in modulation types corresponding to the respective pieces of identification information and different from each other, and emit the modulated pieces of information data as optical signals into free space.

3. The optical space transmission method according to claim 1,
wherein the optical receiver displays the piece of information data by superimposing the piece of information data on the two-dimensional image information including the image of the first light source.

4. An optical space transmission method performed between an optical transmitter and an optical receiver,
the optical transmitter:
causing a light source to multiplex predetermined identification information with information data modulated in a modulation type corresponding to the identification information and to emit the multiplexing result as an optical signal into free space, and
the optical receiver:
acquiring two-dimensional image information including an image of the light source, detecting, in the two-dimensional image information, a change over time of pixel information corresponding to the light source, and reproducing the identification information; and
receiving the optical signal outputted from the light source, demodulating the optical signal in a demodulation type corresponding to the identification information, and reproducing the information data.

5. An optical space transmission apparatus comprising one or more optical transmitters and an optical receiver,
the one or more optical transmitters each including:
an optical identification signal generation section operable to receive a piece of identification information different from other pieces of identification information, operable to electrical-to-optical-convert the piece of identification information, and operable to emit the converted piece of identification information as an optical identification signal into free space;
a modulation section operable to receive a piece of information data, operable to modulate the piece of information data in a modulation type corresponding to the piece of identification information and different from other modulation types, and operable to output the modulated piece of information data; and
an optical data signal generation section operable to receive the modulated piece of information data outputted from the modulation section, operable to electrical-to-optical-convert the modulated piece of information data, and operable to emit the converted piece of information data as an optical data signal into free space, and
the optical receiver including:
a two-dimensional optical-to-electrical conversion section operable to receive two-dimensional image information having a plurality of pieces of pixel information which include images of one or more of the optical identification signals emitted from the one or more optical transmitters, and operable to acquire the two-dimensional image information as screen information in an electrical signal form;
a two-dimensional storage section operable to, at predetermined time intervals, store thereinto the screen information acquired by the two-dimensional optical-to-electrical conversion section;
a coordinate specification section operable to output coordinate information for specifying each pixel of the screen information stored in the two-dimensional storage section;
an information reading section operable to read the plurality of pieces of pixel information from the two-dimensional storage section as needed in accordance with predetermined coordinate information outputted from the coordinate specification section, and operable to reproduce one or more of the pieces of identification information corresponding to the respective one or more optical transmitters, separately;
an optical-to-electrical conversion section operable to receive one or more of the optical data signals emitted from the one or more optical transmitters, and operable to acquire one or more of the modulated pieces of information data by optical-to-electrical-converting the one or more of the optical data signals, separately; and
a demodulation section operable to demodulate, in a demodulation type corresponding to one of the one or more of the pieces of identification information, one of the one or more of the modulated pieces of information data outputted from the optical-to-electrical conversion section, and operable to reproduce one of the one or more of the pieces of information data.

6. The optical space transmission apparatus according to claim 5,
further comprising the same number of a plurality of the demodulation sections as the optical transmitters,
wherein the plurality of the demodulation sections demodulate, in demodulation types corresponding to a plurality of the respective pieces of identification information and different from each other, a plurality of the modulated pieces of information data outputted from the optical-to-electrical conversion section, and reproduce a plurality of the pieces of information data, separately.

7. The optical space transmission apparatus according to claim 5,
wherein the two-dimensional optical-to-electrical conversion section and the optical-to-electrical conversion section are positioned to have the approximately same light-receiving direction.

8. The optical space transmission apparatus according to claim 5,
wherein the two-dimensional optical-to-electrical conversion section and the optical-to-electrical conversion section share the whole or part of an optics system used for input light, cause transmitted light to branch, and each receive the branching light.

9. The optical space transmission apparatus according to claim 5,
further comprising a screen display section operable to receive the screen information outputted from the two-dimensional optical-to-electrical conversion section, and operable to display the screen information on a screen and also to display, with the image of the corresponding optical identification signal, the information data outputted from the demodulation section.

10. The optical space transmission apparatus according to claim 5,
wherein an imaging range which is an area of the screen information acquired by and outputted from the two-dimensional optical-to-electrical conversion section is approximately the same as or smaller than a light-receiving range of the optical-to-electrical conversion section.

11. The optical space transmission apparatus according to claim 10,
wherein, when the imaging range of the two-dimensional optical-to-electrical conversion section is smaller than the light-receiving range of the optical-to-electrical conversion section, presence of, of the one or more optical transmitters, any one or more optical transmitters positioned outside the imaging range of the two-dimensional optical-to-electrical conversion section and also positioned within the light-receiving range of the optical-to-electrical conversion section is displayed on a screen displayed by the screen display section.

12. The optical space transmission apparatus according to claim 5,
wherein the optical identification signal is visible light.

13. The optical space transmission apparatus according to claim 5,
wherein the optical data signal is infrared light.

14. The optical space transmission apparatus according to claim 5,
wherein the two-dimensional optical-to-electrical conversion section is an image sensor.

15. The optical space transmission apparatus according to claim 5,
wherein the optical-to-electrical conversion section is a photo diode or an avalanche photo diode.

16. An optical space transmission apparatus comprising an optical transmitter and an optical receiver,
the optical transmitter including:
a modulation section operable to receive information data, operable to modulate the information data in a modulation type corresponding to identification information, and operable to output the modulated information data; and
an optical signal generation section operable to multiplex, in a predetermined multiplex method, the identification information with the modulated information data outputted from the modulation section, and operable to emit an optical signal acquired by electrical-to-optical-converting the multiplexing result, into free space, and
the optical receiver including:
a two-dimensional optical-to-electrical conversion section operable to receive two-dimensional image information having a plurality of pieces of pixel information which include an image of the optical signal emitted from the optical signal generation section, and operable to acquire the two-dimensional image information as screen information in an electrical signal form;
a two-dimensional storage section operable to, at predetermined time intervals, storing thereinto the screen information acquired by the two-dimensional optical-to-electrical conversion section;
a coordinate specification section operable to output coordinate information for specifying each pixel of the screen information stored in the two-dimensional storage section;
an information reading section operable to read a piece of pixel information from the two-dimensional storage section as needed in accordance with predetermined coordinate information outputted from the coordinate specification section, and operable to extract and reproduce the identification information;
an optical-to-electrical conversion section operable to receive the optical signal emitted from the optical signal generation section, and operable to acquire the multiplexing result by optical-to-electrical-converting the optical signal; and
a demodulation section operable to extract the modulated information data from the multiplexing result outputted from the optical-to-electrical conversion section, operable to demodulate the extracted modulated information data in a demodulation type corresponding to the identification information, and operable to reproduce the information data.

17. The optical space transmission apparatus according to claim 16,
wherein the predetermined multiplex method is a method for frequency-division-multiplexing the identification information into a low-frequency side of the modulated information data.
